(19) United States
(12) Patent Application Publication
(10) Pub. No.: US 2006/0112326 A1
(43) Pub. Date: May 25, 2006

(54) Electronic album management system, computer-readable recording medium storing electronic album management data, mobile communication terminal equipped with electronic album management system, data storage method for electronic album management, and data readout method for electronic album management

(75) Inventors: Ho-Hee Lee, Seocho-Gu (KR); Jae-Hwan Lee, Gangnam-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: Pantech&Curitel Communications, Inc., Seocho-Gu (KR)

(21) Appl. No.: 11/263,859

(22) Filed: Nov. 2, 2005

(30) Foreign Application Priority Data
Nov. 10, 2004 (KR) 10-2004-0091515

(51) Int. Cl. G06F 17/00; G06F 9/00; G06F 3/00; H04N 7/173; H04N 7/025; G06F 17/21

(52) U.S. Cl. 715/500.1; 725/89; 725/34; 715/838; 715/864; 715/753

(57) ABSTRACT

Disclosed are an electronic album management system, a computer-readable recording medium storing electronic album management data, a mobile communication terminal equipped with an electronic album management system, a data storage method for electronic album management and a data readout method for electronic album management. The electronic album management system includes: a frame extraction unit for extracting one frame for configuring an electronic album page from encoded data stored in a memory; a decoding unit for decoding the data extracted from the frame extraction unit; and a first data storage unit for storing the data decoded by the decoding unit in succession to the encoded data stored in the memory.

### BACKGROUND OF THE INVENTION

This application claims the priority of Korean Patent Application No. 2004-91515, filed on Nov. 10, 2004, in the Korean Intellectual Property Office, the disclosure of which is incorporated herein in its entirety by reference.

1. Field of the Invention

The present invention relates to an electronic album management system, a computer-readable recording medium storing electronic album management data, a mobile communication terminal equipped with an electronic album management system, a data storage method for electronic album management and a data readout method for electronic album management and, more particularly, to an electronic album management technique using a mobile communication terminal.

2. Description of Related Art

Conventionally, in order to display pictures or moving images in the form of an album using a mobile communication terminal, encoded data, such as JPG, JPEG, Motion JPEG, or MPEG4, stored in a memory needs to be decoded before being displayed on a display.

While it is simple to decode picture data consisting of a single frame, moving image data undergoes complex processes of opening and decoding the header of the entire moving image file, selecting one frame needed for an electronic album and decoding the selected frame. Consequently, it takes considerable time to display the electronic album on a display.

In case of Qualcomm Solutions (QCAMCODER, QTV) in which image processing is performed in a mobile switching modem (MSM) without using an additional back-end chip for image processing, it is difficult to realize an electronic album screen due to a heavy load imposed on the MSM. In addition, when a number of electronic album pages are viewed in a thumbnail form on a single screen in a wide-screen LCD or the like, a decoding operation is performed for each and every one of the electronic album pages, resulting in a considerable decrease in the operation speed. Further, the greater the size of the electronic album or the higher the resolution, the lower the decoding speed.

### SUMMARY OF THE INVENTION

The present invention provides an electronic album management system, a computer-readable recording medium storing electronic album management data, a mobile communication terminal equipped with an electronic album management system, a data storage method for electronic album management and a data readout method for electronic album management, which are capable of improving a display speed of an electronic album by decoding frame data to be displayed in the form of an electronic album page in advance and storing the decoded frame data when pictures or moving images are stored in a mobile communication terminal.

According to an aspect of the present invention, there is provided an electronic album management system comprising: a frame extraction unit for extracting one frame for configuring an electronic album page from encoded data stored in a memory; a decoding unit for decoding the data extracted from the frame extraction unit; and a first data storage unit for storing the data decoded by the decoding unit in succession to the encoded data stored in the memory.

According to another aspect of the present invention, there is provided a computer-readable recording medium comprising: a first storage area for storing encoded data; and a second storage area for storing decoded data generated by decoding a single frame of data extracted from the encoded data for configuring an electronic album page in succession to the first storage area.

According to another aspect of the present invention, there is provided a mobile communication terminal equipped with an electronic album management system, wherein the electronic album management system comprises: a frame extraction unit for extracting one frame for configuring an electronic album page from encoded data stored in a memory; a decoding unit for decoding the data extracted from the frame extraction unit; and a first data storage unit for storing the data decoded by the decoding unit in succession to the encoded data stored in the memory.

The electronic album management system may further comprise: an encoding unit for encoding raw data captured by a camera; and a second data storage unit for storing the data encoded by the encoding unit in the memory.

The frame extraction unit may extract a screen frame selected by a user in a playback screen of the encoded data as a frame for configuring an electronic album page.

The encoded data stored by the second data storage unit and the decoded data stored by the first data storage unit may be stored into the same file or different files.

The electronic album management system may further comprise: a data readout unit for reading out the decoded data from the memory; and a display output unit for outputting the decoded data read out by the data readout unit to an electronic album screen.

The data readout unit may read out decoded data corresponding to the size of the decoded data starting from the start address of the decoded data.

The start address of the decoded data may be an address shifted by the size of the encoded data from the start address of the encoded data stored in the memory.

The electronic album management system may further comprise an electronic album selection unit for selecting a previous or next electronic album page according to a user's key operation.

According to another aspect of the present invention, there is provided a data storage method for electronic album management, comprising the steps of: extracting one frame for configuring an electronic album page from encoded data stored in a memory; decoding the data extracted from the frame extraction unit; and storing the data decoded by the decoding unit in succession to the encoded data stored in the memory.

The method may further comprise the steps of: encoding raw data captured by a camera; and storing the data encoded by the encoding unit in the memory.

The step of extracting may extract a screen frame selected by a user in a playback screen of the encoded data as a frame for configuring an electronic album page.

The encoded data and the decoded data may be stored into the same file or different files.

According to another aspect of the present invention, there is provided a data readout method for electronic album management, comprising the steps of: reading out decoded data from a memory storing encoded data and decoded data in this order, the decoded data being generated by decoding a single frame of data extracted from the encoded data for configuring an electronic album page; and outputting the read-out decoded data to an electronic album screen.

The step of reading out decoded data may read out decoded data corresponding to the size of the decoded data starting from the start address of the decoded data.

The start address of the decoded data may be an address shifted by the size of the encoded data from the start address of the encoded data stored in the memory.

The method may further comprise selecting a previous or next electronic album page according to a user's key operation.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view showing a mobile communication terminal equipped with a camera;

FIG. 2 is a block diagram showing an electronic album management system in accordance with an embodiment of the present invention;

FIG. 3 is a diagram showing an example of electronic album data stored in a computer-readable recording medium;

FIG. 4 is a flowchart showing a data storage operation for electronic album management in an electronic album management system in accordance with an embodiment of the present invention; and

FIG. 5 is a flowchart showing a data readout operation for electronic album management in an electronic album management system in accordance with an embodiment of the present invention.

### DETAILED DESCRIPTION OF THE INVENTION

Exemplary embodiments of the present invention will be described in detail with reference to the accompanying drawings, where the same elements are denoted by the same reference numerals even though they are depicted in different drawings.

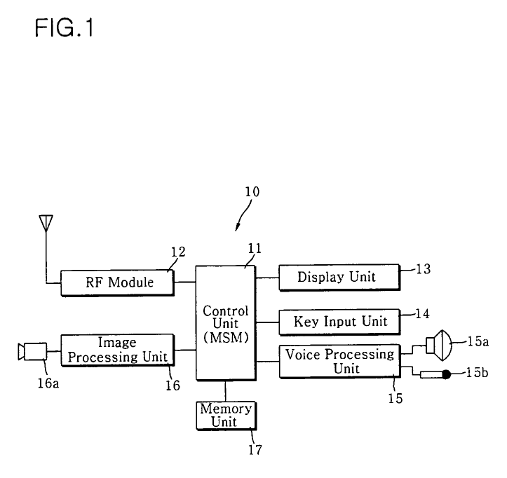

FIG. 1 is a schematic view showing a mobile communication terminal equipped with a camera.

The mobile communication terminal 10 equipped with a camera comprises a control unit 11, a radio frequency (RF) module 12, a display unit 13, a key input unit 14, a voice processing unit 15, an image processing unit 16, and a memory unit 17.

The control unit 11 generally controls the mobile communication terminal. The MSM of Qualcomm Inc. is typically used as the control unit 11.

The RF module 12 transmits/receives voice or data to/from a base station under control of the control unit 11.

The display unit 13 displays various screens used in the mobile communication terminal under control of the control unit 11.

The key input unit 14 sends out a key input signal to the control unit 11 according to a user's key operation.

The voice processing unit 15 processes voice signals outputted through a speaker 15a and voice signals inputted through a microphone 15b.

The image processing unit 16 processes image signals captured by a camera 16a.

The memory unit 17 stores various data used for the mobile communication terminal.

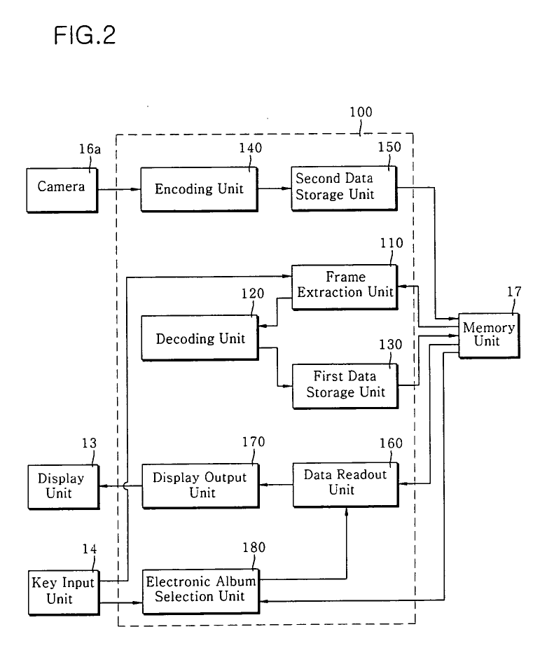

FIG. 2 is a block diagram showing an electronic album management system in accordance with an embodiment of the present invention.

The electronic album management system 100 exists in the form of software which is run by the control unit 11 or image processing unit 16, i.e., back-end chip, in the mobile communication terminal 10. The electronic album management system 100 comprises a frame extraction unit 110, a decoding unit 120 and a first data storage unit 130.

The frame extraction unit 110 extracts a single frame for an electronic album page from encoded data stored in the memory unit 17.

At this time, the frame extraction unit 110 may be constructed to select a certain frame from encoded data and extract it as a frame for configuring the electronic album page. Preferably, the frame extraction unit 110 is constructed to extract a screen frame selected by a user in a playback screen of the encoded data as a frame for configuring the electronic album page.

That is, pictures or moving image data which are downloaded from a server accessed over the Internet or from a personal computer, or captured by the camera 16a are stored in the memory unit 17, such as a flash memory, in the mobile communication terminal 10.

The mobile communication terminal 10 offers a user a menu for realizing pictures or moving images in the form of an electronic album. When the user selects this menu, the user can enter into a screen for configuring an electronic album.

The user selects one frame for configuring an electronic album page through a key operation in the playback screen of pictures or moving images (encoded data) which are reproduced by the user's selection or which are captured by a camera, stored in a memory, and reproduced. Then, the frame extraction unit 110 extracts one frame for configuring an electronic album page from the encoded data stored in the memory.

The decoding unit 120 decodes the data extracted by the frame extraction unit 110.

Since raw pictures or raw moving image data are very large in size, they are encoded into JPG format, JPEG format, Motion JPEG format, MPEG4 format, etc., stored in the memory unit 17. The encoded data are decoded to be reproduced.

Once the user selects one frame for configuring an electronic album page from the encoded data, the selected frame is extracted from the encoded data by the frame extraction unit 110. The decoding unit 120 decodes the extracted data so that an electronic album page can be read from the memory and displayed on a display without a decoding process when the electronic album page is displayed.

The first data storage unit 130 stores the encoded data followed by the decoded data decoded by the decoding unit 120 in the memory unit 17.

That is, the decoded data decoded by the decoding unit 120 is stored in the memory unit 17. At this time, the first data storage unit 130 stores the decoded data in succession to the encoded data so that an unnecessary index management process can be avoided when displaying an electronic album page. At this time, the encoded data and the decoded data can be stored into the same file or different files.

In accordance with another embodiment of the present invention, the electronic album management system 100 further comprises an encoding unit 140 and a second data storage unit 150.

The encoding unit 140 encodes raw data captured by the camera 16a.

The second data storage unit 150 stores the encoded data encoded by the encoding unit 140 in the memory unit 17.

The present embodiment is a configuration for realizing pictures or moving images captured by the camera in the form of an electronic album. Raw pictures or raw moving image data captured by the camera 16a in the mobile communication terminal 10 according to a user's operation are encoded by the image processing unit 16a or the control unit 11 and stored in the memory unit 17.

The electronic album management system 100 extracts one frame for configuring an electronic album page from the encoded data stored in the memory unit 17 by means of the frame extraction unit 110, decodes the extracted frame data by means of the decoding unit 120, and stores the decoded frame data in the memory unit 17 through the first data storage unit 130.

In accordance with another embodiment of the present invention, the electronic album management system 100 further comprises a data readout unit 160 and a display output unit 170.

The data readout unit 160 reads decoded data from the memory unit 17.

That is, since the memory unit 17 stores encoded data followed by decoded data into the same file or different files, the data readout unit 160 reads the decoded data from the memory unit 17 by reading decoded data as much as the size of the decoded data starting from the start address of the decoded data.

In the case where the decoded data is stored in succession to the encoded data into the same file, the start address of the decoded data is an address shifted by the size of the encoded data from the start address of the encoded data stored in the memory. Thus, it is possible to read out the decoded data from the memory unit 17 by reading out the decoded data as much as the size of the decoded data starting from an address shifted by the size of the encoded data from the start address of the encoded data.

In the case where the decoded data is stored in succession to the encoded data into different files, it is preferred to store information defining a relation between the encoded data and the decoded data and read out decoded data as much as the size of the decoded data starting from the start address of the decoded data by referring to that information when reading out the decoded data. In this case, the information defining the relation between the encoded data and the decoded data can be recorded as the header information of the file or can be stored in another file.

The display output unit 170 outputs the decoded data read out by the data readout unit 160 to an electronic album display.

That is, when the decoded data is read out from the memory unit 17 by the data readout unit 160, the electronic album management system 100 outputs the read-out decoded data to the electronic album display by means of the display output unit 170.

In accordance with another embodiment of the present invention, the electronic album management system 100 further comprises an electronic album selection unit 180.

A previous or next electronic album page is selected through the electronic album selection unit 180 according to a user's key operation.

That is, each of the electronic album pages can be displayed on a single screen, or a number of electronic album pages can be displayed on a single screen in thumbnail form. The electronic album selection unit 180 allows a user to select a previous or next electronic album page according to the user's key operation. When the user selects a desired electronic album page, the encoded data corresponding to the selected electronic album page is read out from the memory unit and reproduced.

Accordingly, since frame data to be displayed in the form of an electronic album page is decoded in advance and stored upon storing pictures or moving images in a mobile communication terminal, it is possible to read and display decoded data on a display without the need to perform a decoding process when the electronic album is displayed on the display, thereby improving the display speed of the electronic album.

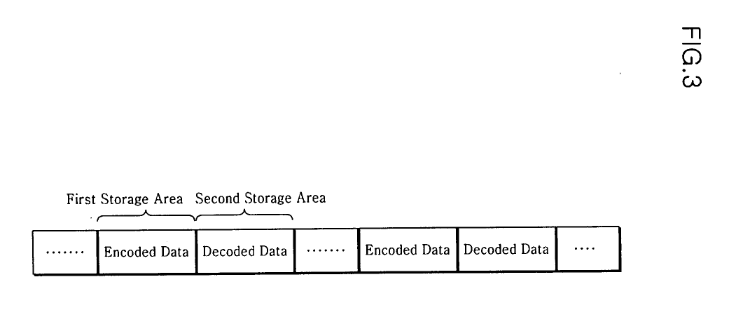

FIG. 3 shows an example of electronic album data stored in a computer-readable recording medium. The memory unit 17 comprises a first storage area for storing encoded data and a second storage area for storing decoded data generated by decoding a single frame of data extracted from the encoded data for configuring an electronic album page in succession to the encoded data.

The encoded data and the decoded data can be stored into the same file or different files.

In addition, it is preferred that a number of pairs consisting of encoded data and decoded data are stored in the memory unit 17, where the decoded data is stored in succession to the encoded data. The electronic albums can be displayed on different screens or on the same screen according to a user's operation.

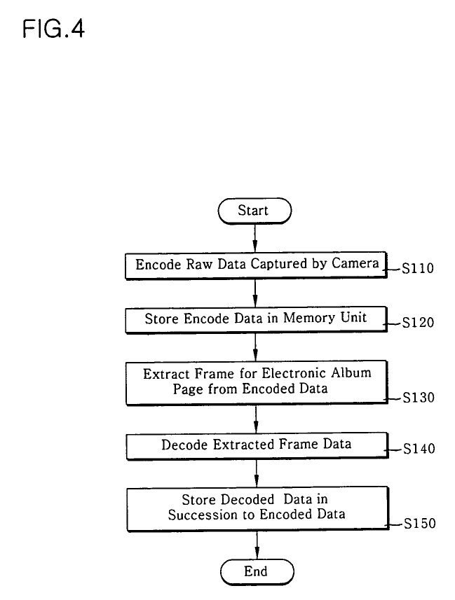

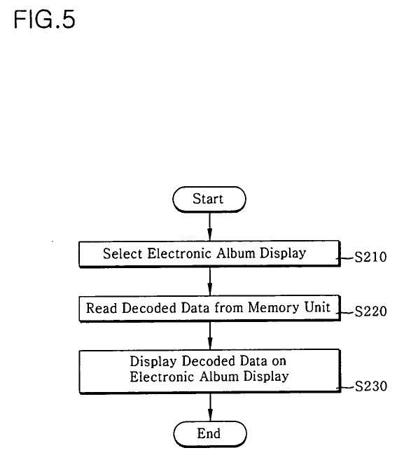

Referring to FIGS. 4 and 5, a data storage operation and a data readout operation for electronic album management in an electronic album management system in accordance with the present invention will be described.

FIG. 4 is a flowchart showing a data storage operation for electronic album management in an electronic album management system in accordance with an embodiment of the present invention. The electronic album management system 100 extracts one frame for configuring an electronic album page from encoded data stored in a memory (step S130), decodes the data extracted in step S130 (step S140), and stores the data decoded in step S140 in succession to the encoded data stored in the memory (step S150).

Meanwhile, in case of electronic album management for pictures or moving image data captured by a camera, the electronic album management system 100 encodes raw data captured by the camera (step S110), and stores the data encoded in step S110 (step S120).

Preferably, in step S130, a screen frame selected by a user from a playback screen of the encoded data is extracted as a frame for configuring an electronic album page. The encoded data stored in step S120 and the decoded data stored in step S150 can be stored into the same file or different files.

FIG. 5 is a flowchart showing a data readout operation for electronic album management in an electronic album management system in accordance with an embodiment of the present invention. The electronic album management system 100 reads out decoded data from the memory unit 17 (step S220), and outputs the decoded data read in step S220 to the electronic album display (step S230).

At this time, the decoded data generated by decoding a single frame of data extracted from the encoded data for configuring an electronic album page is stored in succession to the encoded data in the memory unit 17.

In step S220, it is preferred to read out decoded data as much as the size of the decoded data starting from the start address of the decoded data. The start address of the decoded data is an address shifted by the size of the encoded data from the start address of the encoded data stored in the memory unit 17.

That is, since the decoded data is stored into the same file or different files in the memory unit 17 in succession to the encoded data, the electronic album management system 100 reads out decoded data from the memory unit 17 by reading out decoded data as much as the size of the decoded data starting from the start address of the decoded data in step S220.

At this time, in the case where the decoded data is stored in succession to the encoded data into the same file, the start address of the decoded data is an address shifted by the size of the encoded data from the start address of the encoded data stored in the memory. Thus, it is possible to read out the decoded data from the memory unit 17 by reading out the decoded data as much as the size of the decoded data starting from an address shifted by the size of the encoded data from the start address of the encoded data.

In the case where the decoded data is stored in succession to the encoded data into different files, it is preferred to store information defining a relation between the encoded data and the decoded data and read out decoded data as much as the size of the decoded data starting from the start address of the decoded data by referring to that information when reading out decoded data in step S220. In this case, the information defining the relation between the encoded data and the decoded data can be recorded as the header information of the file and/or can be stored in another file.

The data readout method for electronic album management may further comprise an electronic album selection step S210 for selecting a previous or next electronic album page according to a user's key operation.

That is, each of the electronic album pages can be displayed on a single screen, or a number of electronic album pages can be displayed on a single screen in thumbnail form. The electronic album management system 100 selects a previous or next electronic album page according to a user's key operation in step S210. When the user selects a desired electronic album page, the encoded data corresponding to the selected electronic album page is read out from the memory unit and reproduced.

Accordingly, since frame data to be displayed in the form of an electronic album page is decoded in advance and is stored when pictures or moving images are stored in a mobile communication terminal, it is possible to read and display decoded data on a display without the need to perform a decoding process when the electronic album is displayed on the display, thereby improving the display speed of the electronic album.

While the present invention has been described with reference to exemplary embodiments thereof, it will be understood by those skilled in the art that various changes in form and detail may be made therein without departing from the scope of the present invention as defined by the following claims.

What is claimed is:

1. An electronic album management system comprising:
a frame extraction unit for extracting one frame for configuring an electronic album page from encoded data stored in a memory;
a decoding unit for decoding the data extracted from the frame extraction unit; and
a first data storage unit for storing the data decoded by the decoding unit in succession to the encoded data stored in the memory.

2. The system of claim 1, further comprising:
an encoding unit for encoding raw data captured by a camera; and
a second data storage unit for storing the data encoded by the encoding unit in the memory.

3. The system of claim 2, wherein the frame extraction unit extracts a screen frame selected by a user in a playback screen of the encoded data as a frame for configuring an electronic album page.

4. The system of claim 2, wherein the encoded data stored by the second data storage unit and the decoded data stored by the first data storage unit are stored into a single file.

5. The system of claim 2, wherein the encoded data stored by the second data storage unit and the decoded data stored by the first data storage unit are stored into different files.

6. The system of claim 2, further comprising:
a data readout unit for reading out the decoded data from the memory; and
a display output unit for outputting the decoded data read out by the data readout unit to an electronic album display.

7. The system of claim 6, wherein the data readout unit reads out decoded data corresponding to the size of the decoded data starting from the start address of the decoded data.

8. The system of claim 7, wherein the start address of the decoded data is an address shifted by the size of the encoded data from the start address of the encoded data stored in the memory.

9. The system of claim 8, further comprising an electronic album selection unit for selecting a previous or next electronic album page according to a user's key operation.

10. A mobile communication terminal equipped with an electronic album management system, wherein the electronic album management system comprises:
a frame extraction unit for extracting one frame for configuring an electronic album page from encoded data stored in a memory;
a decoding unit for decoding the data extracted from the frame extraction unit; and
a first data storage unit for storing the data decoded by the decoding unit in succession to the encoded data stored in the memory.

11. The mobile communication terminal of claim 10, wherein the electronic album management system further comprises:
an encoding unit for encoding raw data captured by a camera; and
a second data storage unit for storing the data encoded by the encoding unit in the memory.

12. The mobile communication terminal of claim 11, wherein the frame extraction unit extracts a screen frame selected by a user in a playback screen of the encoded data as a frame for configuring an electronic album page.

13. The mobile communication terminal of claim 11, wherein the encoded data stored by the second data storage unit and the decoded data stored by the first data storage unit are stored into a single file.

14. The mobile communication terminal of claim 11, wherein the encoded data stored by the second data storage unit and the decoded data stored by the first data storage unit are stored into different files.

15. The mobile communication terminal of claim 11 further comprises:
a data readout unit for reading out the decoded data from the memory; and
a display output unit for outputting the decoded data read out by the data readout unit to an electronic album screen.

16. The mobile communication terminal of claim 15, wherein the data readout unit reads out decoded data corresponding to the size of the decoded data starting from the start address of the decoded data.

17. The mobile communication terminal of claim 16, wherein the start address of the decoded data is an address shifted by the size of the encoded data from the start address of the encoded data stored in the memory.

18. The mobile communication terminal of claim 17, wherein the electronic album management system further comprises an electronic album selection unit for selecting a previous or next electronic album page according to a user's key operation.

19. A data storage method for electronic album management, comprising the steps of:
extracting one frame for configuring an electronic album page from encoded data stored in a memory;
decoding the data extracted from the frame extraction unit; and
storing the data decoded by the decoding unit in succession to the encoded data stored in the memory.

20. The method of claim 19, further comprising the steps of:
encoding raw data captured by a camera; and
storing the data encoded by the encoding unit in the memory.

21. The method of claim 20, wherein the step of extracting extracts a screen frame selected by a user in a playback screen of the encoded data as a frame for configuring an electronic album page.

22. The method of claim 20, wherein the encoded data and the decoded data are stored into a single file.

23. The method of claim 20, wherein the encoded data stored and the decoded data are stored into different files.
